(19) United States
(12) Patent Application Publication
(10) Pub. No.: US 2007/0213016 A1
(43) Pub. Date: Sep. 13, 2007

(54) Remote control holder with speaker activation

(76) Inventor: Howard Murray Hoffman, Highland Village, TX (US)

Correspondence Address: Howard Murray Hoffman, 3322 Castlewood Blvd., Highland Village, TX, 75077, US

(21) Appl. No.: 11/370,449

(22) Filed: Mar. 8, 2006

(51) Int. Cl. H04B 1/02

(52) U.S. Cl. 455/92

(57) ABSTRACT

One of the most asked question in the TV room of most household is “Where's the remote?” Remote Controls for a TV, DVD, VHS, etc. are very often misplace. When the user removes the Remote Control from this invention (the Remote Control Holder with Speaker Activation), internal control circuitry is activated starting a software timer and lighting a LED to let the user know that the control circuitry is active. If the user replaces the Remote Control in the Remote Control Holder with Speaker Activation before the software timer reaches a predetermined time, the control circuitry's software timer is reset and the control circuitry goes into standby (to sleep). However if the user doesn't return the Remote Control to the Remote Control Holder with Speaker Activation, a brief sound (beep) or one of a plurality of voice sayings are played and will periodically repeat until the user replaces the Remote control or m the power switch off.

BACKGROUND OF THE INVENTION

I. Field of tie Invention

This invention relates generally to the field of article holders and particularly to the- field of holders of visual and remote control device

II. Description of Prior Art

A number of different remote holders have been developed. One style of holder is designed to provide protection for the remote control. Another holder design is to hold a plurality of remote controls. Yet another holder is designed for attachment to furniture for the convenience of the user. Still another has a tether attached between it an the remote control.

One object of the present invention is to provide an aural reminder to replace the remote in a known place. Another object of die present invention is to provide the user with unlimited range of motion of die remote control and not be limited in its travel as with the holder with a tether attached. Another object of this invention is that its design allows the user to place items other than a remote control such as a cell phone or keys in the holder, and be reminded to place it in a known place.

### SUMMARY OF THE INVENTION

The invention disclosed herein is a holder for remote control devices or other objects that the user wishes to keep track of. The Remote Control Holder with Speaker Activation has an opening well in the top for easy access to a variety of objects placed in the Remote Control Holder with Speaker Activation. The invention disclosed has a hinged base in an essentially horizontal position located at the bottom of the opening well. This allows easy access for small items such as a ring of keys as well as for larger item as a remote control. An activating switch is coupled to the hinged base. The activating switch provides the signal to the internal electronics consisting of a PCB with a Speech Synthesizer, which has a software program and sound samples (both speech and sound effects), and an attach speaker to reproduce the sounds. Included in this invention is a 3 position function switch the user has access to. The three choices are: 1) off, 2) Voice or 3) Beep. In this embodiment, when the function switch in position #2, the program provides the user with 5 different sayings spaced 30 seconds apart then repeats. When the user selects position #3 with the function switch, the user hears a beep every 30 seconds. The sounds in both position #2 and #3 continue until the user replaces the object taken from the hinged base. After a brief pause the user is provided with a thank-you message then the unit sleeps. This invention is battery operated so that it can be easily placed anywhere it is convenient for the user.

### BRIEF DESCRIPTION OF THE DRAWINGS

For a better understanding of the present invention and to show more clearly how it may be carried into effect, reference will now be made by way of example to the accompanying drawings, which show an apparatus according to the preferred embodiment of the present invention and in which:

FIG. 1 is an exploded perspective view from the front and upper right side showing the relation of the various components of the Remote Control Holder with Speaker Activation.

FIG. 2 is the Block Diagram of the electrical circuit used in the Remote Control Holder with Speaker Activation.

FIG. 3 is a 3D exploded view from the front and lower right side showing the preferred embodiment of the present invention.

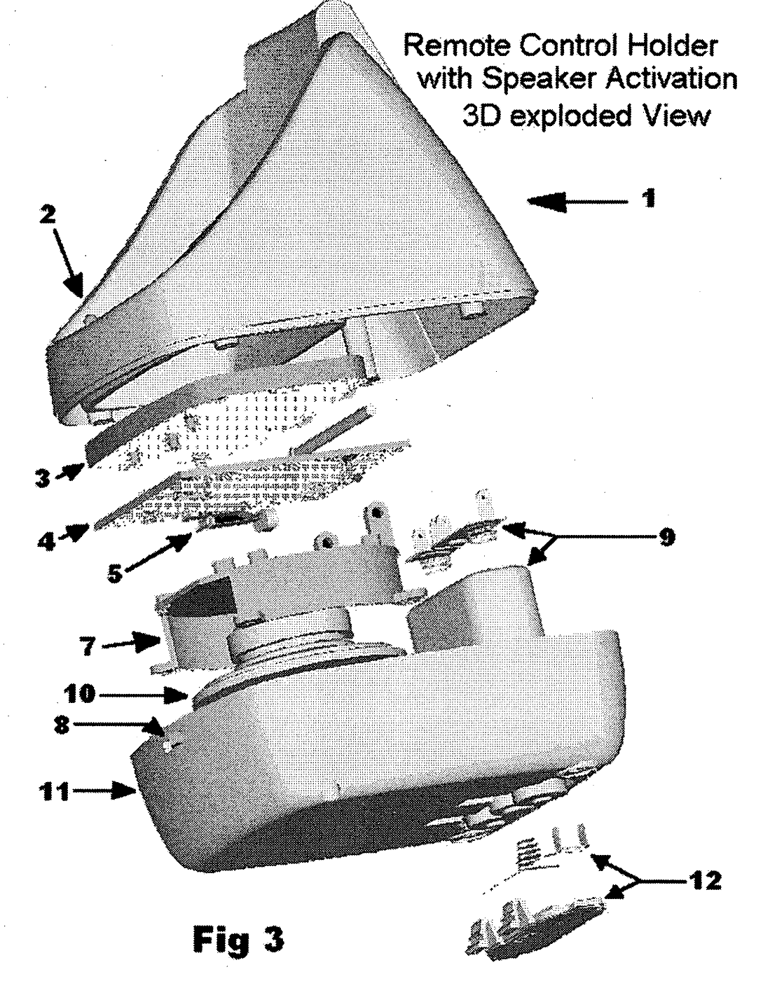

FIG. 4 shows the control logic for the Remote Control Holder with Speaker Activation in the current embodiment.

### DETAILED DESCRIPTION OF THE PREFERRED EMBODIMENTS

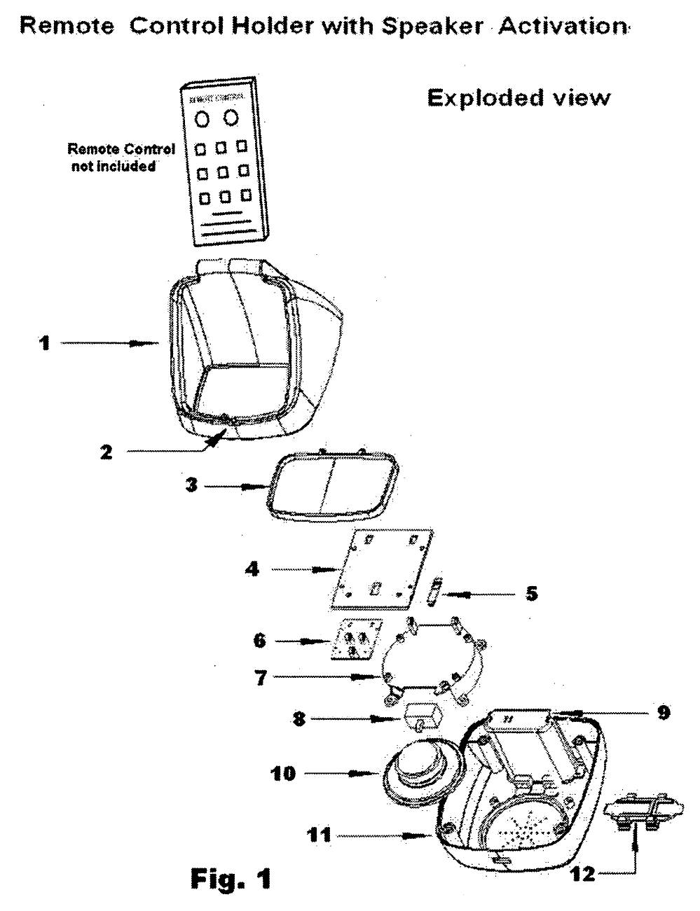

As shown in FIG. 1, the indicator light 2 is located in plain view of the user in the Top Housing 1 of the preferred embodiment. The hinged base 3 is located adjacent to the bottom of the Top Housing 1 and is hinged from the speaker cover mounting plate 7. The underside of the hinged base 3 has a protrusion which mates with the activating switch 5. The weight of the remote control cell phone or keys on the hinged base 3 is sufficient to hold the activating switch 5 in the open- (off) position. With the items removed the activating switch is in the closed (on) position. The switch plate 4 has the PCB with the Speech synthesizer 14 and its associated circuitry and the activating switch mounted on it. The switch plate 4 is mounted to the speaker cover mounting plate. The bottom housing 11 has a slot in the front of it for the 3 way switch 8 [off, voice, beep selector]. The Speaker cover mounting plate 8 secures the speaker 10 to the bottom housing 11. Also located in the bottom housing 11 is a battery compartment containing contacts for 3 “AA” batteries. The batteries are inserted into the bottom of the bottom housing 11 and secured in place with a battery compartment cover 12. The battery compartment cover 12 has contacts arranged so that the batteries are electrically in series to give 4.5 volts.

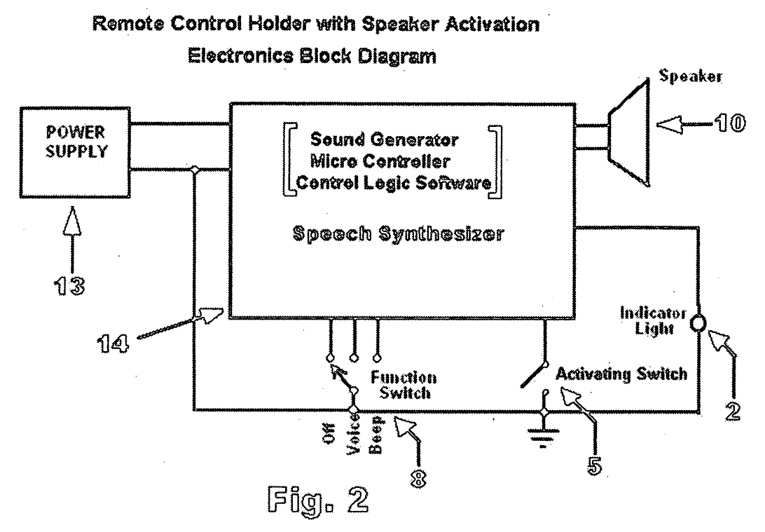

Referring to FIG. 2, the integrated circuit 14, in the preferred embodiment, is a low cost speech synthesis chip with built in microcontroller, on-chip memory to store digital data representative of phrases of speech and of sound effects (beeps), and an on-chip driver to directly drive a speaker. The speech synthesizer 14 is preferably any of the EM55XXX series of speech synthesizers available from Elan Microelectronics Corp. of Hsinchu City, Taiwan, Republic of China Another valuable feature of this series of speech synthesizers is the ability to go to “sleep” by program command, which is a low current mode where there is no activity in the speech synthesis chip.

As shown in FIG. 2, the speech synthesizer 14 is directly connected to a speaker 10 through 2 audio output lines. The speech synthesizer, 14 is also connected to an indicator Light 17, which is an LED in the preferred embodiment, that can be programmed to-blink periodically or be on steady when the Remote Control Holder with Speaker Activation is in operation. Function switch 8 allows the user to turn the Remote Control Holder with Speaker Activation Off or select either voice sayings or a beep as sounds produced under program control, when the Remote Control is removed by the user from the Remote Control Holder with Speaker Activation. To one skilled in the arts, the voice sayings or beeps can be easily programmed with music or other sound effects.

When the function switch 8 is in the off position the speech synthesizer is programmed to remain in the low current “sleep” mode. Conversely, in the preferred embodiment, when the function switch 8 is in either the voice or the beep position, then the activating switch 5 is functional. When the, activating switch 5 is in the “on” position, the speech synthesizer “wakes up” and starts the software program.

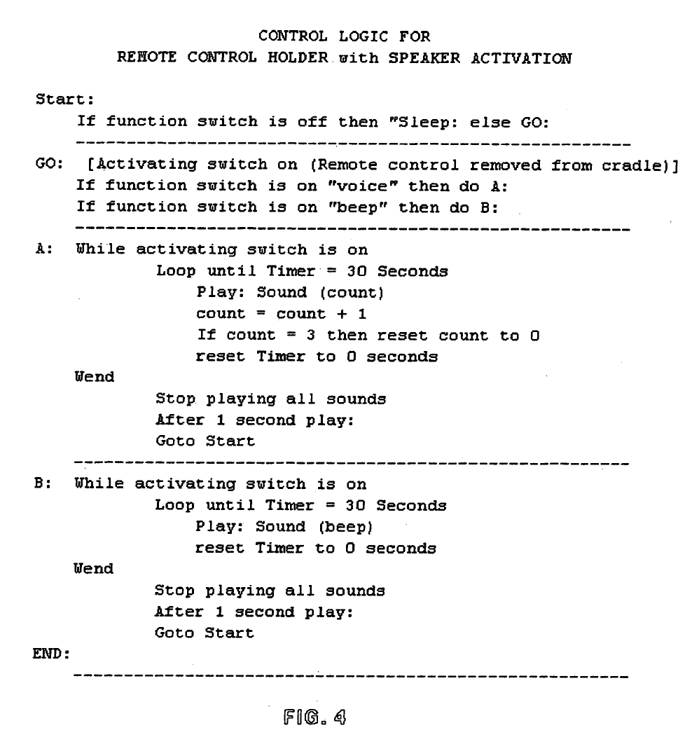

Note in FIG. 4 that in the preferred embodiment that in section A: of the control logic “count” is set to five (5). This provides for five different vocal saying before repeating. It is known to one skilled in the arts that the actual number of sayings possible is limited only by the ROM Size of the, speech synthesizer used.

I claim:

1. A Remote Control Holder with Speaker Activation featuring an electronic circuit with a preprogrammed speech synthesizer that is activated by the removal of a remote control or other objects that are placed on the hinged base.

2. The speech synthesizer of claim 1 contains a program which controls the order and time at which the sounds [voice or sound effects] are played.

3. The Remote Control Holder with Speaker Activation in claim 1 has a switch associated with the hinged base to sense the absence or presence of the weight of a Remote Control or other objects the user may place thereon. Said switch signals the program contained in the speech synthesizer the proper branch in the program to take.

4. The Remote Control Holder with Speaker Activation in claim 1 additionally has a user activated switch to give the user 3 choices of operation.
(a) Off. [for when the unit is not in use]
(b) Voice: [when the user wishes verbal- reminders to replace the removed remote control or object]
(c) Beep: [used when the user doesn't want verbal reminders]

5. The remote control holder in claim 1 contains in the program a “thank you” message when the remote control or removed objects are placed in the remote control holder's hinged base. The remote control holder with speaker activation then goes into low power mode.

6. The Remote Control Holder with Speaker Activation in claim 1 has an LED on the rim of the top housing that lights when the object is removed from the holder reminding the user that the object has not been returned to the Remote Control Holder with Speaker Activation.
